(19) United States
(12) Patent Application Publication
(10) Pub. No.: US 2007/0013758 A1
(43) Pub. Date: Jan. 18, 2007

(54) Inkjet image forming apparatus including drying device

(75) Inventors: Gui-taek Lim, Suwon-si (KR); Masahiko Habuka, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/444,321

(22) Filed: Jun. 1, 2006

(30) Foreign Application Priority Data
Jul. 18, 2005 (KR) 10-2005-0064785

(51) Int. Cl. B41J 2/01

(52) U.S. Cl. 347/102

(57) ABSTRACT

An inkjet image forming apparatus includes a printhead including a nozzle unit having a length corresponding to a width of a sheet of paper, and a drying device to simultaneously dry ink ejected onto the paper by sucking air from around the paper and to discharge the paper using the sucking force.

### CROSS-REFERENCE TO RELATED APPLICATIONS

This application claims the priority of Korean Patent Application No. 10-2005-0064785, filed on Jul. 18, 2005, in the Korean Intellectual Property Office, the disclosure of which is incorporated herein in its entirety by reference.

### BACKGROUND OF THE INVENTION

1. Field of the Invention

The present general inventive concept relates to an inkjet image forming apparatus, and more particularly, to an inkjet image forming apparatus including a unit that serves both as a drying device to dry ink ejected onto a sheet of paper and a paper discharging device to discharge paper.

2. Description of the Related Art

Generally, an inkjet image forming apparatus forms an image on a sheet of paper by ejecting ink from an inkjet printhead placed at a predetermined distance from the paper. Although the inkjet printhead that ejects ink on the sheet of paper while traveling along a width direction of the sheet of paper, that is, perpendicular to a feeding direction of the sheet of paper (which is known as a ‘shuttle type inkjet printhead’), has been widely used for image forming apparatuses, recently, an inkjet printhead that includes a nozzle unit having a length corresponding to a width of the sheet of paper to eject ink on to the sheet of paper (which is known as a ‘line-type inkjet printhead’) is being considered for high-speed printing.

When the inkjet printhead of the shuttle type inkjet printhead prints the image while traveling in the width direction of the sheet of paper, ink ejected from the inkjet printhead can be sufficiently dry. However, when the inkjet printhead of the line-type inkjet printhead prints the image at a high speed and performs a relatively large amount of printing in the same time, there may not be enough time for the ink to dry. Thus, if the sheets of paper on which the ink is ejected are not sufficiently dried and are continuously stacked in a discharging tray, the insufficiently dried ink on a previously discharged sheet of paper stains a back surface of the sheet of paper stacked thereon, causing a smearing effect that deteriorates an image quality.

U.S. Pat. No. 6,578,959 discloses a conventional printer in which ink ejected onto a sheet of paper to print an image is dried using microwaves. However, since the microwaves may spread, a drying stability cannot be ensured, and, in addition, a device for generating the microwaves is complicated and uses much power.

Meanwhile, the sheet of paper on which the image has been formed passes between a discharging roller and a star-wheel placed above the discharging roller, which are rotatably engaged with each other. The sheet of paper is then discharged in a discharging tray. At this moment, star-wheel marks are left on the sheet of paper. As such, it is desirable to remove the star-wheel marks to improve the appearance of the paper. However, the star-wheel is required to stably discharge the paper in the conventional printer.

### SUMMARY OF THE INVENTION

The present general inventive concept provides an inkjet image forming apparatus including a drying device to simultaneously dry and discharge a sheet of paper on which an image is printed.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a drying device usable in an image forming apparatus, the drying device including a dryer tube having a hollow pipe shape, each end of which is blocked, and having an outer circumference on which a plurality of penetrating holes are formed, a secondary tank installed to enclose the dryer tube while exposing a predetermined portion of the dryer tube to an outside of the dryer tube such that the dryer tube can contact a sheet of paper in a width direction of the paper, and a pumping unit to suck air from the secondary tank.

The foregoing and/or other aspects and utilities of the present general inventive concept may also be achieved by providing an inkjet image forming apparatus, including a printhead including a nozzle unit having a length corresponding to a width of a sheet of paper, and a drying device to simultaneously dry the ink ejected onto the paper by sucking air from around the paper and to discharge the paper using a sucking force generated when the air is sucked.

The foregoing and/or other aspects and utilities of the present general inventive concept may also be achieved by providing a drying device usable in an image forming apparatus to form an image on a sheet of paper, including a tank unit disposed on a feeding path of a sheet of paper with an image, and having an inner space and an opening, and a dryer tube rotatably disposed in the inner space of the tank unit, having a circumference to define a space portion, and having a plurality of penetrating holes formed on the circumference, a portion of the circumference with a portion of the penetrating holes being exposed through the opening of the tank unit to the feeding path to dry the image and to feed the sheet of paper.

The foregoing and/or other aspects and utilities of the present general inventive concept may be achieved by providing an image forming apparatus, including an image forming unit and a drying device, the image forming unit disposed on a feeding path to form an image on a sheet of paper, and the drying device including a tank unit disposed on a feeding path of a sheet of paper with an image, and having an inner space and an opening, and a dryer tube rotatably disposed in the inner space of the tank unit, having a circumference to define a space portion in the inner space, and having a plurality of penetrating holes formed on the circumference, a portion of the circumference with a portion of the penetrating holes being exposed through the opening of the tank unit to the feeding path to dry the image and to feed the sheet of paper.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view schematically illustrating an inkjet image forming apparatus including a drying device according to an embodiment of the present general inventive concept;

FIG. 2 is a perspective view illustrating the drying device of FIG. 1;

FIG. 3 is a cross-sectional view illustrating the drying device taken along line II-II′ in FIG. 2; and

FIG. 4 is a side view illustrating operations of the drying device of FIG. 1, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

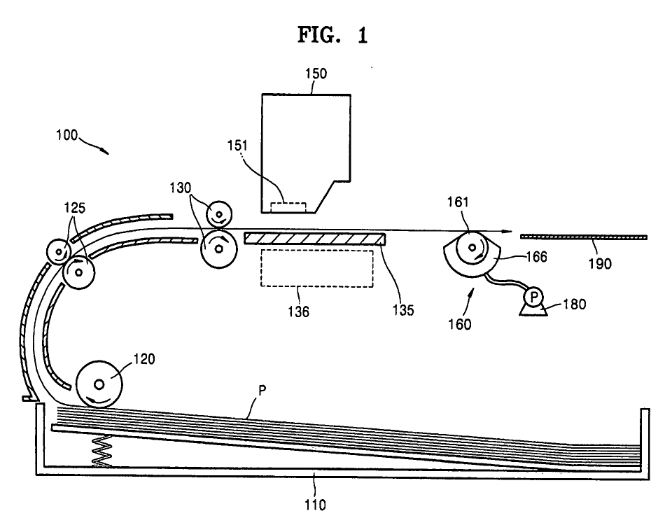

FIG. 1 is a view schematically illustrating an inkjet image forming apparatus 100 including a drying device 160 according to an embodiment of the present general inventive concept. Referring to FIG. 1, the inkjet image forming apparatus 100 includes a paper feeding cassette 110, a pick-up roller 120 that picks up a sheet of paper P from the paper feeding cassette 110, feed rollers 125 and 130 that convey the picked up sheet of paper P, an inkjet printhead 150 to form an image on the sheet of paper P, and the drying device 160 that simultaneously dries and discharges the sheet of paper P on which the image has been printed. The inkjet printhead 150 and related components to form the image may be collectively called an image forming unit

The pick up roller 120 picks up sheets of paper P stacked in the paper feeding cassette 110 one by one.

The feed rollers 130 convey the sheet of paper P drawn out by the pick-up roller 120 such that the sheet of paper P passes beneath an inkjet printhead 150. The feed rollers 130 may be two rollers positioned such that they contact each other and the sheet of paper P passes between the two rollers.

A platen 135 is installed between the feed rollers 130 and the drying device 160 to support a back surface of the sheet of paper P while the sheet of paper P is passing between the feed rollers 130. The inkjet printhead 150 is installed above the platen 135 to eject ink onto the sheet of paper P to form the image.

The inkjet printhead 150 is a line-type inkjet printhead suitable for high-speed printing. The line-type inkjet printhead 150 may be fixedly disposed in a widthwise direction of the paper P which is perpendicular to a feeding direction of the sheet of paper P, and includes a nozzle unit 151 having a length that corresponds to a width of the paper P. The nozzle unit 151 of the inkjet printhead 150 is placed at a predetermined distance apart from a top surface of the paper P. It is possible that the inkjet printhead 150 may be movable in the widthwise direction to increase a resolution of the image.

The inkjet printhead 150 performs a capping operation in which the nozzle unit 151 is capped to prevent ink from drying, a wiping operation to wipe ink remaining on the nozzle unit 151, and a spitting operation in which remaining ink is exhausted to prevent the nozzle unit 151 from being clogged with the ink in a maintenance region 136.

The drying device 160 is installed between the printhead 150 and a discharging tray 190, sucks air around the sheet of paper P, on which ink has been ejected, to absorb heat from the sheet of paper P and ink, and discharges the sheet of paper P using the sucking force simultaneously. Moreover, the drying device 160 includes a dryer tube 161, a secondary tank 166, and a pumping unit 180.

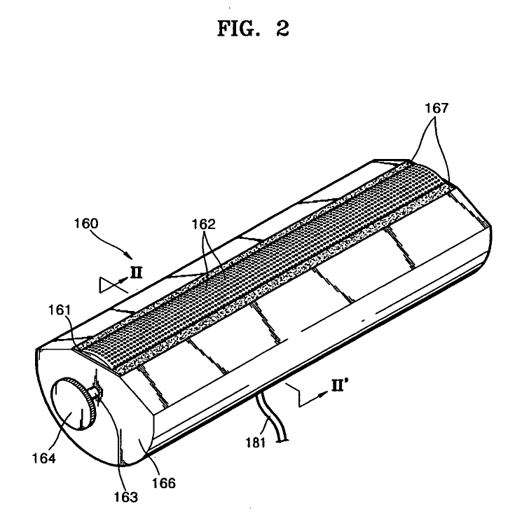

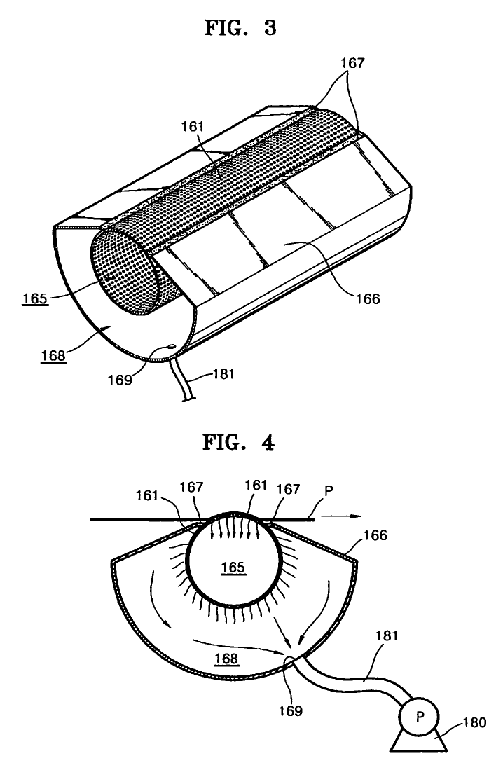

FIG. 2 is a perspective view illustrating the drying device 160 of FIG. 1. FIG. 3 is a cross-sectional view illustrating the drying device 160 taken along line II-II′ in FIG. 2. Referring to FIGS. 1, 2, and 3, the dryer tube 161 is disposed in the secondary tank 166 to be partially exposed to an outside of the drying device 160, and installed on a conveying path, along which the sheet of paper P is conveyed, in the width direction of the sheet of paper P The dryer tube 161 is a hollow pipe in which a space portion 165 is formed and each end thereof is blocked. A plurality of penetrating holes 162 are formed in an outer circumference of the dryer tube 161 at predetermined intervals, and air can flow into and out of the space portion 165 by passing through the penetrating holes 162.

The secondary tank 166 has an opening through which a predetermined part of the secondary tank 166 corresponding to an area of the dryer tube 161 is exposed to the outside of the drying device 160 so as for the dryer tube 161 to contact the sheet of paper P, and an inner space 168 is formed such that a second part of the secondary tank 166 surrounds the dryer tube 161. The opening is formed in the width direction of the paper P. The opening may have a width corresponding to the width of the paper P and a length in the paper feeding direction. An outflow opening 169 is formed on a side of the secondary tank 166 to be connected to the pumping unit 180 (illustrated in FIG. 4) and a hose 181.

An axle or shaft 163 is formed on each end of the dryer tube 161 to allow the dryer tube 161 to rotate with respect to the secondary tank 166 and/or the platen 135, and a gear portion 164 is formed on an end of the shaft 163 such that a driving motor (not shown) may be connected thereto. Thus, the shaft 163 may penetrate from the secondary tank 166 and can be rotatably supported. However, the shape of the dryer tube 161 is not limited to the above embodiment, and may have various shapes.

Since the secondary tank 166 has to be sealed, sealing members 167 are formed on gaps between the exposed portions of the dryer tube 161 and a boundary defining the opening of the secondary tank 166 so that the inner space is blocked from the outside. The sealing member 167 may be made of a rubber or ceramic material to provide an air-tight seal against the dryer tube 161.

The pumping unit 180 is connected to the secondary tank 166 using the outflow opening 169 and the hose 181, and thus discharges the air from the inner space 168 to the outside of the drying device 160.

Drying and discharging operations of the drying device 160 with the above structure will be described below with reference to drawings.

FIG. 4 is a side view illustrating operations of the drying device 160 of FIG. 1, according to an embodiment of the present general inventive concept. Referring to FIGS. 1 through 4, the paper P on which the ink is ejected while the paper P is passing by the nozzle unit 151 of the printhead 150 is conveyed to the drying device 160 by the feed roller 130. The pumping unit 180 sucks the air from the inside of the inner space 168 of the secondary tank 166 through the hose 181.

Referring to FIG. 4, since the secondary tank 166 is sealed, the air inside the space portion 165 flows to the inner space 168 by passing through the plurality of penetrating holes 162 formed in the dryer tube 161 which is enclosed by the inner space 168. Then, external air enters the space portion 165 through the penetrating holes 162 on the exposed portion of the dryer tube 161 exposed to face the sheet of paper P.

That is, as the air flows into the space portion 165 through the penetrating holes 162 on the exposed portion of the dryer tube 161 exposed to face the sheet of paper P, the air of the space portion 165 flows to the inner space 168 through the penetrating holes 162 enclosed by the inner space 168 of the secondary tank 166. The air of the inner space 168 flows out towards the pumping unit 180 through the outflow opening 169 due to the sucking force of the pumping unit 180.

The sheet of paper P facing the exposed portion of the dryer tank 161 exposed from the secondary tank 166 is attached to the dryer tank 161 by a sucking force of the pumping unit 180 which sucks the air into the space portion 165 through the penetrating holes 162.

The dryer tube 161 conveys the sheet of paper P in a direction indicated by an arrow while rotating about the shaft 163. As the exposed portion of the dryer tube 161 which has faced the paper P rotates to move from the opening toward the inside of the secondary tank 166, the exposed portion is covered by the sealing member 167 and blocked from the outside, and hence the sucking force of the pumping member 180 is no longer applied to the sheet of paper P so that the sheet of paper P is separated from the dryer tube 161. A leading edge of the sheet of paper P is fed toward the document tray 190 according to the rotation of the dryer tube 161 while the paper P is in close contact with the dryer tube 161 exposed through the opening of the secondary tank 166 according to the suction force of the dryer tube 161. When a trailing edge of the paper P passes the dryer tube 161, the paper P is discharged into the document tray 190.

While the above operations are repeated, the sheet of paper P passes by the drying device 160 and then is discharged and stacked in the discharging tray 190.

As described above, according to the present general inventive concept, an inkjet image forming apparatus includes a drying device acting also as a discharging device, which dries ink to prevent image quality from being deteriorated and discharges a sheet of paper having no discharging marks thereon.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A drying device, comprising:
a dryer tube having a hollow pipe shape, each end of which is blocked, and having an outer circumference on which a plurality of penetrating holes are formed;
a secondary tank installed to enclose the dryer tube while exposing a predetermined portion of the dryer tube to an outside thereof such that the dryer tube can contact a sheet of paper in a width direction of the paper; and
a pumping unit to suck air from the secondary tank.

2. The drying device of claim 1, wherein the secondary tank further comprises a plurality of sealing members that seal gaps between the exposed portions of the dryer tube and the secondary tank.

3. The drying device of claim 2, wherein the sealing members are made of one of a rubber material and a ceramic material.

4. The drying device of claim 1, further comprising a shaft formed by the dryer tube connected to a driving motor to rotate the dryer tube.

5. The drying device of claim 4, wherein the dryer tube is supported such that the dryer tube can rotate in the secondary tank.

6. The drying device of claim 1, wherein the secondary tank comprises an outflow opening which is formed thereon and is connected to the pumping unit to discharge the air.

7. An inkjet image forming apparatus, comprising:
a printhead including a nozzle unit having a length corresponding to a width of a sheet of paper; and
a drying device to simultaneously dry the ink ejected onto the paper by sucking air from around the paper and to discharge the paper using a sucking force generated when the air is sucked.

8. The inkjet image forming apparatus of claim 7, wherein the drying device comprises:
a dryer tube having a hollow pipe shape, each end of which is blocked, and having an outer circumference on which a plurality of penetrating holes are formed;
a secondary tank installed to enclose the dryer tube and to expose a predetermined portion of the dryer tube to an outside thereof such that the dryer tube can contact a sheet of paper in a width direction of the paper; and
a pumping unit to suck air from the secondary tank.

9. The inkjet image forming apparatus of claim 8, wherein the secondary tank further comprises a plurality of sealing members that seal a gap between the secondary tank and the exposed portions of the dryer tube.

10. The inkjet image forming apparatus of claim 9, wherein the sealing members are made of one of a rubber material and a ceramic material.

11. The inkjet image forming apparatus of claim 8, wherein the dryer tube rotates by being connected to a driving unit.

12. The inkjet image forming apparatus of claim 11, wherein the dryer tube is supported such that the dryer tube can rotate in the secondary tank.

13. The inkjet image forming apparatus of claim 8, wherein the secondary tank comprises an outflow opening connected to the pumping unit to discharge the air.

14. A drying device usable in an image forming apparatus to form an image on a sheet of paper, comprising:
a tank unit disposed on a feeding path of a sheet of paper with an image, and having an inner space and an opening; and
a dryer tube rotatably disposed in the inner space of the tank unit, having a circumference to define a space portion, and having a plurality of penetrating holes formed on the circumference, a portion of the circumference with a portion of the penetrating holes being exposed through the opening of the tank unit to the feeding path to dry the image and to feed the sheet of paper.

15. An image forming apparatus, comprising:
an image forming unit disposed on a feeding path to form an image on a sheet of paper; and
a drying device, comprising:
a tank unit disposed on a feeding path of a sheet of paper with an image, and having an inner space and an opening, and
a dryer tube rotatably disposed in the inner space of the tank unit, having a circumference to define a space portion in the inner space, and having a plurality of penetrating holes formed on the circumference, a portion of the circumference with a portion of the penetrating holes being exposed through the opening of the tank unit to the feeding path to dry the image and to feed the sheet of paper.

16. The image forming apparatus of claim 15, further comprising:
a pump unit connected to the drying device to suck air around the sheet of paper through the portion of the penetrating holes so that the image is dried.

17. The image forming apparatus of claim 15, wherein the drying device further comprises:
a shaft formed on the dryer tube and protruding from the tank unit;
a gear portion formed on the shaft end; and
a driving unit to drive the gear portion to rotate the shaft and the dryer tube with respect to the tank unit to feed the sheet of paper.

18. The image forming apparatus of claim 15, wherein the drying device further comprises:
a seal disposed between the tank unit and the dryer tube.

19. The image forming apparatus of claim 15, wherein the opening of the tank unit has a width corresponding to a width of the sheet of paper and a length in a feeding direction of the sheet of paper.

20. The image forming apparatus of claim 15, wherein the portion of the circumference of the dryer tube has a width corresponding to the opening.
